(19) United States
(12) Patent Application Publication
(10) Pub. No.: US 2026/0200458 A1
(43) Pub. Date: Jul. 16, 2026

(54) PREDICTIVE MOTOR TORQUE MARGIN CALCULATION FOR POWER SPLIT HYBRID SYSTEMS WITH A BOOST CONVERTER

(71) Applicant: FCA US LLC, Auburn Hills, MI (US)

(72) Inventors: Daniel Berger, Auburn Hills, MI (US); Christoph Tischendorf, Auburn Hills, MI (US); Ameya Basutkar, Auburn Hills, MI (US); Mary Claire Sullivan, Auburn Hills, MI (US); Shichao Huo, Auburn Hills, MI (US); Nadirsh Patel, Auburn Hills, MI (US); Ashay Sharma, Auburn Hills, MI (US)

(21) Appl. No.: 19/017,992

(22) Filed: Jan. 13, 2025

(51) Int. Cl. B60W 20/11; B60L 15/20; B60W 20/17; B60W 50/00

(52) U.S. Cl. CPC B60W 20/11; B60L 15/2045; B60W 20/17; B60W 50/0097; B60L 2210/14; B60L 2210/42; B60L 2240/423; B60L 2240/526

(57) ABSTRACT

Predictive torque control systems and methods for an electrified vehicle include controlling a boost converter configured to convert and selectively boost a direct current (DC) voltage from a high voltage bus and a high voltage battery system to alternating current (AC) voltages supplied to first and second electric motors of a power split hybrid transmission, determining base torque commands for the first and second electric motors based on a driver torque request, predicting torque margins for the first and second electric motors based on an anticipated transient operating event of the engine, and proactively controlling the boost converter based on the predicted torque margins for the first and second electric motors, respectively.

### FIELD

The present application generally relates to vehicle power split hybrid systems with a boost converter and, more particularly, to a control strategy for predictive motor torque margin calculation for such systems.

### BACKGROUND

Some electrified vehicles have a power split hybrid powertrain comprising an engine and a hybrid transmission including two electric motors and a boost converter for boosting the voltage at a high voltage bus to a higher voltage for one or both of the electric motors. The boost converter primarily uses a low voltage map to minimize the electrical losses and reduce fuel consumption during most of the operating points of the electrical motors. This strategy works well for most of the normal driving behavior as the driver does not need full torque capability and high change of motor torque. One negative effect, however, is that during certain driving situations, the torque capability may be limited against the possible maximum torque capability of the electric motors to fulfill driver torque request and may also be limited against quick motor torque command changes for certain use cases for powertrain strategy such as lash crossing. Accordingly, while such conventional control strategies do work for their intended purpose, there exists an opportunity for improvement in the relevant art.

### SUMMARY

According to one example aspect of the invention, a predictive torque control system for an electrified vehicle is presented. In one exemplary implementation, the predictive torque control system comprises an engine, a power split hybrid transmission connected to the engine and comprising first and second electric motors, a boost converter configured to convert and selectively boost a direct current (DC) voltage from a high voltage bus and a high voltage battery system to alternating current (AC) voltages supplied to the first and second electric motors of the power split hybrid transmission, and a control system configured to determine base torque commands for the first and second electric motors based on a driver torque request, predict torque margins for the first and second electric motors based on an anticipated transient operating event of the engine, and proactively control the boost converter based on the predicted torque margins for the first and second electric motors, respectively.

In some implementations, the control system is further configured to detect the anticipated transient operating event from a set of transient operating events including at least one of (i) a start operation of the engine, (ii) an entry to or exit from a deceleration fuel cutoff (DFCO) of the engine, (iii) an entry to fast path torque control of the engine, and (iv) an entry to or exit from a noise/vibration/harshness (NVH) zone of the engine.

In some implementations, the control system is further configured to detect the anticipated transient operating event from a plurality of transient operating events including (i) a start operation of the engine, (ii) an entry to or exit from a DFCO of the engine, (iii) an entry to fast path torque control of the engine, and (iv) an entry to or exit from an NVH zone of the engine. In some implementations, the control system is further configured to predict torque margins for each of the plurality of anticipated operating events and determine the predicted torque margins for the first and second electric motors as a maximum of the predicted torque margins.

In some implementations, the proactive control of the boost converter decreases losses at an electrical system of the electrified vehicle. In some implementations, the proactive control of the boost converter increases a responsiveness of the power split hybrid transmission to the transient operating event of the engine.

In some implementations, the anticipated transient operating event is a start operation of the engine, and wherein one of the first and second electric motors of the power split hybrid transmission is configured to control start/stop operation of the engine. In some implementations, the anticipated transient operating event is an entry to or exit from a DFCO of the engine. In some implementations, the anticipated transient operating event is an entry to fast path torque control of the engine. In some implementations, the anticipated transient operating event is entry to or exit from an NVH zone of the engine where electric motor assistance is needed to decrease an NVH of the engine.

According to another example aspect of the invention, a predictive torque control method for an electrified vehicle having an engine, a power split hybrid transmission connected to the engine and comprising first and second electric motors, and a boost converter is presented. In one exemplary implementation, the predictive torque control method comprises controlling, by a control system of the electrified vehicle, the boost converter configured to convert and selectively boost a DC voltage from a high voltage bus and a high voltage battery system to AC voltages supplied to the first and second electric motors of the power split hybrid transmission, determining, by the control system, base torque commands for the first and second electric motors based on a driver torque request, predicting, by the control system, torque margins for the first and second electric motors based on an anticipated transient operating event of the engine, and proactively controlling, by the control system, the boost converter based on the predicted torque margins for the first and second electric motors, respectively.

In some implementations, the predictive torque control method further comprises detecting, by the control system, the anticipated transient operating event from a set of transient operating events including at least one of (i) a start operation of the engine, (ii) an entry to or exit from a DFCO of the engine, (iii) an entry to fast path torque control of the engine, and (iv) an entry to or exit from an NVH zone of the engine.

In some implementations, the predictive torque control method further comprises detecting, by the control system, the anticipated transient operating event from a plurality of transient operating events including (i) a start

operation of the engine, (ii) an entry to or exit from a DFCO of the engine, (iii) an entry to fast path torque control of the engine, and (iv) an entry to or exit from an NVH zone of the engine. In some implementations, the predictive torque control method further comprises predicting, by the control system, torque margins for each of the plurality of transient operating events and determining, by the control system, the predicted torque margins for the first and second electric motors as a maximum of the predicted torque margins.

In some implementations, the proactive controlling of the boost converter decreases losses at an electrical system of the electrified vehicle. In some implementations, the proactive controlling of the boost converter increases a responsiveness of the power split hybrid transmission to the transient operating event of the engine.

In some implementations, the anticipated transient operating event is a start operation of the engine, and wherein one of the first and second electric motors of the power split hybrid transmission is configured to control start/stop operation of the engine. In some implementations, the anticipated transient operating event is an entry to or exit from a DFCO of the engine. In some implementations, the anticipated transient operating event is an entry to fast path torque control of the engine. In some implementations, the anticipated transient operating event is entry to or exit from an NVH zone of the engine where electric motor assistance is needed to decrease an NVH of the engine.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a power split hybrid transmission and a boost converter and example predictive control system according to the principles of the present application;

FIGS. 2A-2E are functional block diagrams of example system architectures for the predictive torque control system according to the principles of

### The Present Application; and

FIG. 3 is a flow diagram of an example predictive torque control method for an electrified vehicle having a power split hybrid transmission and a boost converter according to the principles of the present application.

### DESCRIPTION

As previously discussed, some electrified vehicles have a power split hybrid powertrain comprising an engine and a hybrid transmission including two electric motors and a boost converter for boosting the voltage at a high voltage bus to a higher voltage for one or both of the electric motors. The boost converter primarily uses a low voltage map to minimize the electrical losses and reduce fuel consumption during most of the operating points of the electrical motors. This strategy works well for most of the normal driving behavior as the driver does not need full torque capability and high change of motor torque. One negative effect, however, is that during certain driving situations, the torque capability may be limited against the possible maximum torque capability of the electric motors to fulfill driver torque request and may also be limited against quick motor torque command changes for certain use cases for powertrain strategy such as lash crossing.

To counteract this, the boost converter is able to switch the voltage level and provide a higher possible torque capability when needed. In today's vehicles, boosting only commanded through the motor torque commands, or rather the motor torque command is only considered to trigger a higher voltage request and increase the maximum capability for the electric motors. This means that higher electrical losses are accepted which comes together with a higher fuel consumption during these certain events. Thus, operating points at a high boost voltage level are typically minimized. Thus, these conventional solutions can lead to delayed motor torque actuation time, which can lead to driveline disturbances and delayed driver torque fulfillment during certain driving scenarios.

Accordingly, an improved torque control strategy for a power split hybrid system with a boost converter is presented herein. This control strategy generates electric motor torque margins to control the boost voltage behavior during certain scenarios such as engine start/stop, dynamic motor torques during fuel cut off/on, and running through a noise/vibration/harshness (NVH) zone. These margins are used for predictive motor command calculation, resulting in accelerated motor torque request fulfillment, and for switching between different voltage levels on boost converter side to fulfill the driver demand, resulting in reduced electrical losses and fuel consumption. The conventional solutions discussed above are not able to pre-calculate a specific needed torque margin for defined events outside the normal driving behavior. The predictive calculation also compensates for controller area network (CAN) delay between the motor torque request and a needed time for the system controller to react on a higher needed torque request.

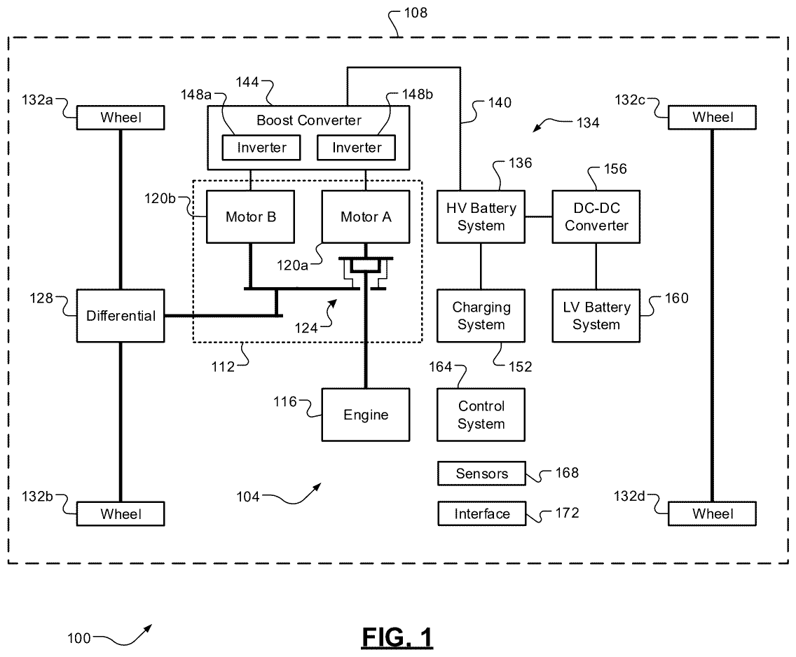

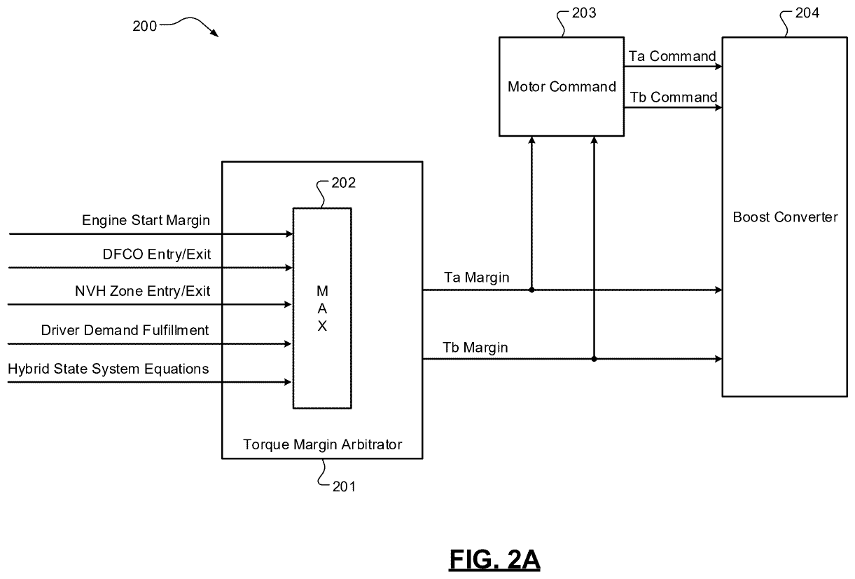

Referring now to FIG. 1, a functional block diagram of an electrified vehicle 100 having an example predictive control system 104 according to the principles of the present application is illustrated. The electrified vehicle 100 generally comprises an electrified powertrain 108 that includes a power split hybrid transmission 112 and an internal combustion engine 116. The engine 116 is configured to combust a mixture of air and fuel (gasoline, diesel, etc.) to generate torque. The power split hybrid transmission 112 generally comprises first and second electric motors 120a, 120b (also “Motor A” and “Motor B,” respectively, and collectively “electric motors 120”) and a system of shafts/clutches 124 for controlling the power through the transmission 112 and via a differential 128 to an axle or half-shafts and to front wheels 132a, 132b (separate from a rear wheels 132c, 132 of the driveline). Motor A 120a can also be configured to control stop/start of the engine 116 (e.g., via a crankshaft or engine output shaft).

The electric motors 120 are powered by electrical energy supplied by an electrical system 134 comprising a high voltage battery system 136 via a high voltage bus 140 and a boost converter 144. As shown, the boost converter 144 includes two inverters 148a, 148b (e.g., each having a three half-bridge configuration with six switches) configured to both boost the DC voltage at the high voltage bus 140 (e.g., via a separate internal boost or DC-DC converter, not shown) and generate three phase voltage control signals (e.g., pulse-width modulated, or PWM signals) to windings (not shown) of the respective electric motors 120. It will be appreciated that this is merely a simple representation of the boost converter 144 and that the boost converter 144 could have a different configuration while providing this described functionality. The electrified powertrain 108 further comprises a charging system 152 for external recharging of the high voltage battery system 136 and another DC-DC converter 156 (i.e., separate from the boost converter 140) for stepping down the DC voltage at the high voltage bus 140, such as for supporting a low voltage (e.g., 12V) battery system 160 and respective low voltage accessory components or loads (not shown).

The electrified powertrain 108 is controlled by a controller or control system 164, which could include a plurality of electronic control units (ECUs) (e.g., an engine controller, a motor controller, etc.), and which could also include a supervisory and secondary or sub-controller arrangement (e.g., a supervisory electrified vehicle control unit, or EVCU, could oversee secondary or sub-controllers). The electrified vehicle 100 also includes sensors 168 configured to measure various parameters of the electrified powertrain 108 including, but not limited to, shaft speeds/accelerations/torques, temperatures, and electrical parameters (current, voltage, etc.). Lastly, the electrified vehicle 100 can further include a driver interface 172 for receiving driver inputs, such as, but not limited to, an input via an accelerator pedal (not shown) indicating a driver torque request for the electrified powertrain 108. The control system 164 is also configured to perform the predictive torque margin control techniques of the present application, which will now be described in even greater detail.

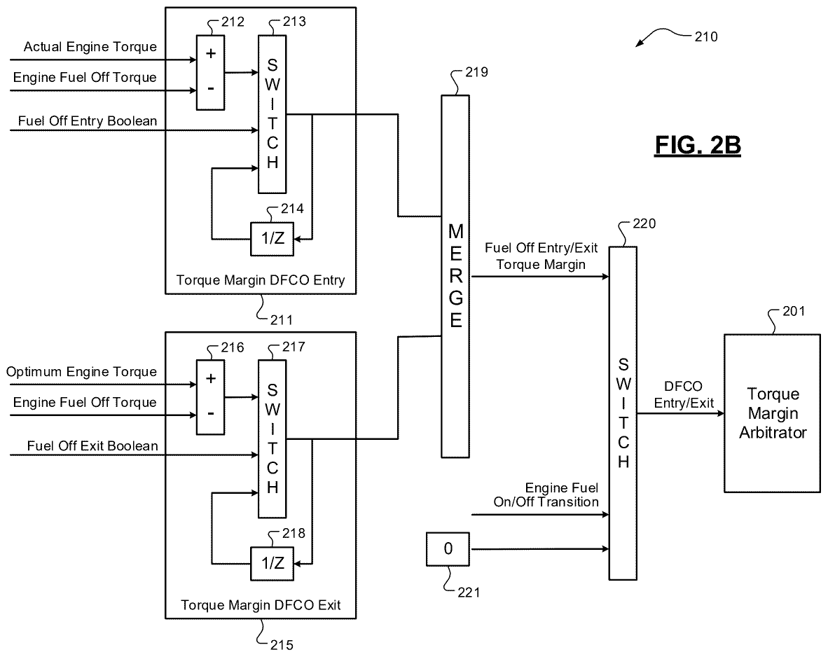

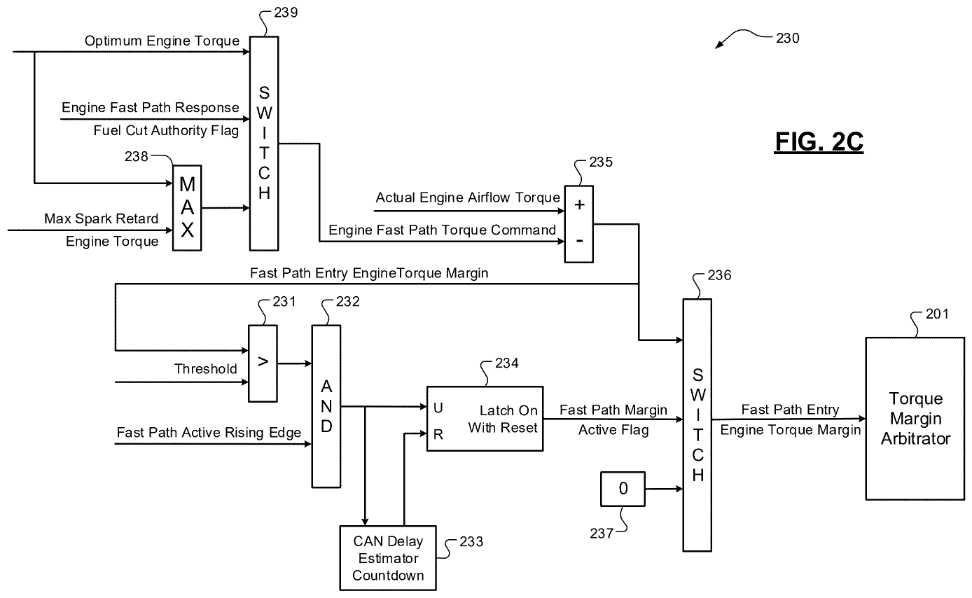

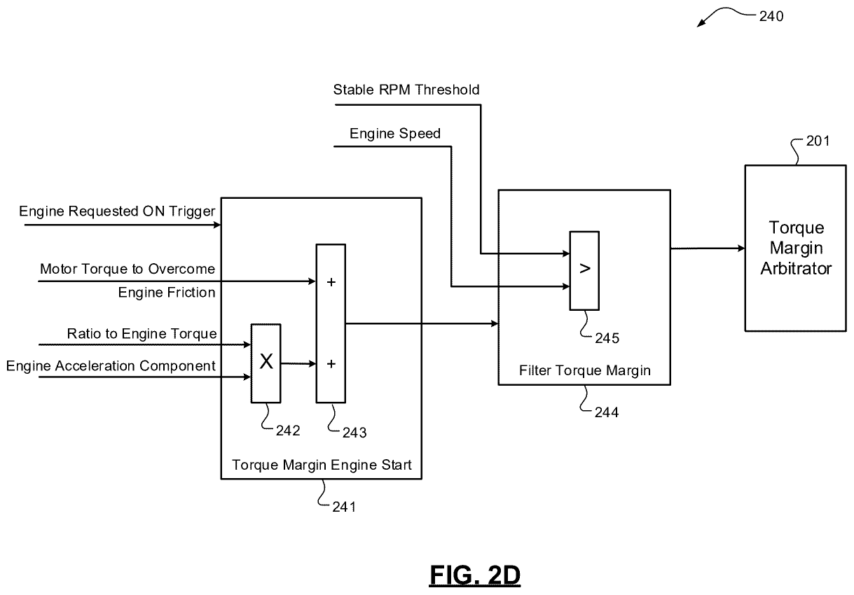

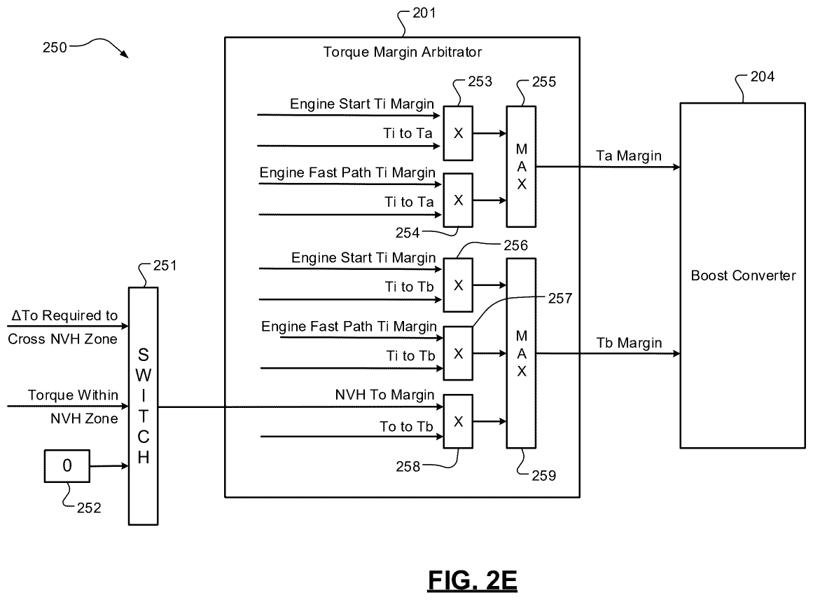

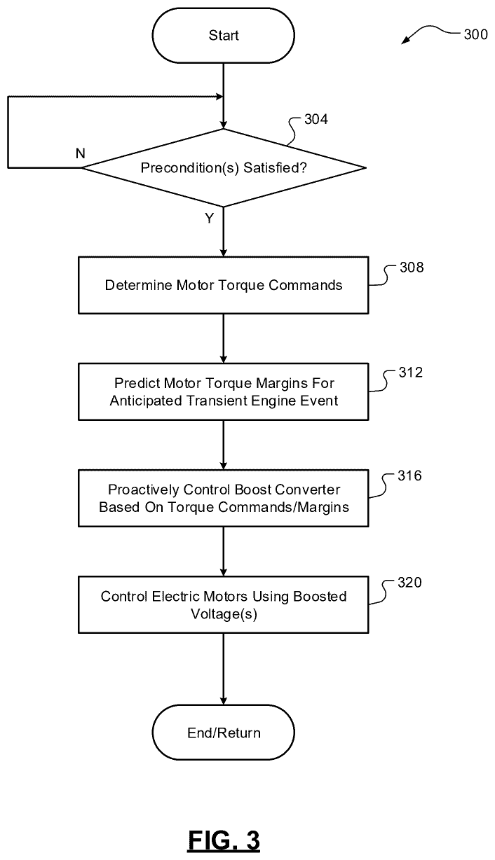

Referring now to FIGS. 2A-2E and with continued reference to FIG. 1, functional block diagrams of example system architectures 200, 210, 230, 240, and 250 for the predictive torque control system 104 according to the principles of the present application is illustrated. FIG. 2A illustrates a high-level system architecture 200 for the predictive torque control system 104. As shown, a torque margin arbitration or arbitrator block 201 receives a plurality of torque related inputs for arbitration. These include an engine start torque margin, a deceleration fuel cut-off (DCFO) entry/exit torque margin, an engine fast path entry torque margin, an NVH zone entry/exit torque margin and a driver demand fulfillment torque margin, and a set of hybrid system state equations (e.g., relating to the donut-space method for determining optimal torque values between an engine and electric motors). A maximum block 202 determines two maximum values of various combinations of these inputs (as described more fully below) to determine torque margins Ta Margin and Tb Margin for the electric motors 120a and 120b, respectively. These torque margins are fed to both a motor controller block 203 and a boost converter control block 204. The motor controller block 203 further determines torque commands Ta Command and Tb Command for the electric motors 120a and 120b, respectively, and provides these torque commands to the boost converter control block 204.

In FIG. 2B, an example system architecture 210 for DFCO entry/exit and, more specifically, for calculating a fuel on/off motor torque margin is illustrated. In a torque margin fuel off entry block 211, a difference block 212 calculates a difference between the actual engine torque and the fuel off engine torque. This difference is provided to a switch block 213, which uses a fuel off entry Boolean variable or flag to control switching between the calculated difference and a Z-transform 214 of an output of the switch block 213. The output of this switch block 213 is provided to a merge block 219. In a similar torque margin fuel off exit block 215, a difference block 216 calculates a difference between the optimum engine torque and the engine fuel off torque. This difference is provided to a switch block 217, which uses a fuel off exit Boolean variable or flag to control switching between the calculated difference and a Z-transform 218 of an output of the switch block 217. The output of this switch block 217 is also provided to the merge block 219. The merge block 219 merges these two inputs to obtain a fuel off entry/exit torque margin. This value is provided to another switch block 220, which uses an engine on/off transition Boolean variable or flag to control switching between the provided value and a zero value 221. The output of switch block 220—the DFCO entry/exit torque margin—is finally provided to the torque

### Margin Arbitrator Block 201.

In FIG. 2C, another example system architecture 230 for calculating an engine fast path motor torque margin is illustrated. Engine fast path torque control involves controlling fast path toque actuators (fuel, spark, etc.) as opposed to slow path torque actuators (e.g., airflow actuators). While shown and described separately from DFCO, it will be appreciated that engine fast path torque control may entail fuel cutoff, but can also be limited to merely spark retardation. Comparison block 231 determines the greater of the fast path entry torque margin and a calibratable threshold and provides the greater value to and an AND block 232 that passes or latches the value through in response to the fast path active signal rising edge. The output of the AND block 232 is provided to an on latch with reset block 234 and to a CAN delay estimator countdown block 233. This output is latched as the output of block 234 and is reset when CAN delay estimator countdown expects the fast path transition to be completed. The output of block 234 is provided as a control input (a fast path margin active Boolean variable or flag) to a switch block 236, along with an output value from a difference block 235 and a zero 237.

The difference block 235 calculates a difference between the actual engine airflow torque and an engine fast path torque command which is also the fast path entry torque margin that is initially provided to comparator block 231. Based on the control input, the switch block 236 outputs either the calculated difference from block 235 or the zero from block 237. The output from the switch block 236 is provided to the torque margin arbitrator 201. The engine fast path torque command used by the difference block 235 is calculated as follows. A MAX block 238 determines a maximum of an optimum engine torque and an engine torque at maximum spark retardation (max spark retard engine torque). This value is provided to a switch block 239, which uses an engine fast path response fuel cut authority Boolean variable or flag as a control input to select or pass either the value from block 238 or the optimum engine torque (which could involve fuel cutoff).

In FIG. 2D, an example system architecture 240 for calculating the torque margin required for engine starts is illustrated. A torque margin engine start block 241 determines an engine start torque margin. Within the torque margin engine start block 241, a multiplier block 242 calculates a product of an engine torque ratio and an engine acceleration component needed to sustain combustion and cancel engine compression pulses. This product is fed to a summation block 243 that calculates a sum of the product and a maximum motor torque needed to break the engine free from friction (i.e., to start spinning). This torque margin engine start block 241 is activated in response to an engine requested on trigger signal. The engine start torque margin is provided to a filter torque margin block 244 that outputs an engine torque margin to the torque margin arbitrator 201. The filter torque margin block 244 filters out the engine torque margin to zero after a stable engine speed (e.g., revolutions per minute, or RPM) is reached. Within the filter torque margin block 244 is a comparator block 245 that determines the greater of the stable engine speed or RPM threshold and the actual or measured engine speed. This process is performed so as to only use the boosted margin till the engine speed is stabilized during a start.

Finally, in FIG. 2E, an example system architecture 250 for calculating of a To NVH margin (where “To” represents total powertrain torque) and the final torque margin arbitration, which correlates to block 201 of FIG. 2A. Specifically, this system architecture 250 illustrates what the torque margin arbitrator does 201, which is converting the torque margins in the engine torque domain to the motor torque domain (considering the torque ratio of the transmission). Essentially, this system architecture 250 shows two separate functions: (1) one function for To NVH torque margin calculation and (2) another function for final maximum (MAX) arbitration of all margin requestors and conversion into the correct motor torque domain. As shown in FIG. 2E, a switch block 251 determines an NVH To margin by selecting one of a delta To to cross the NVH zone, a torque within the NVH zone, and zero 252. Within the torque margin arbitrator block 201, the engine start Ti (engine torque) margin and a Ti to Ta (Motor A torque) ratio are multiplied by multiplier block 253. The engine fast path Ti margin and the Ti/Ta ratio are also multiplied by multiplier block 254. The products of multiplier blocks 253 and 254 are then fed to a maximum block 255, which determines a maximum of the two values, which is then output as the Ta Margin (Motor A torque margin) to the boost converter control block 204.

In a separate portion within the torque margin arbitrator block 201, the engine start Ti margin and a Ti to Tb (Motor B torque) ratio are multiplied by multiplier block 256. The engine fast path Ti margin and the Ti/Tb ratio are multiplied by multiplier block 257, and the NVH To margin (from block 251) and a To to Tb ratio (To/Tb) are also multiplied at multiplier block 258. The products of multiplier blocks 256, 257, and 258 are then fed to a maximum block 259, which determines a maximum of the three values, which is then output as the Tb Margin (Motor B torque margin) to the boost converter control block 204.

Referring now to FIG. 3 and with continued reference to the previous figures, a flow diagram of an example predictive torque margin control method 300 for an electrified vehicle having a power split hybrid transmission and a boost converter according to the principles of the present application are illustrated. While this method 300 references the electrified vehicle 100 and its components for descriptive/illustrative purposes, it will be appreciated that the method 300 could be applicable to any suitably configured electrified vehicle with a boosted converter, including electrified vehicles that do not have power split hybrid transmissions. The method 300 begins at optional 304 where the control system 164 determines whether a set of one or more optional preconditions are satisfied. These precondition(s) could include, for example only, the electrified powertrain 108 being powered up and operational and there being no malfunctions or faults present that would negatively impact or otherwise inhibit the operation of the predictive torque control techniques of the present application. When false, the method 300 ends or returns to 304. When true, the method 300 proceeds to 308.

At 308, the control system 164 determines base torque commands for the electric motors 120 based on a driver torque request and other relevant factors (engine on/off status, component speeds/temperatures, etc.). At 312, the control system 164 determines predictive torque margins for the electrified motors 120a and 120b for an anticipated transient operating event of the engine 116 as previously described herein. This could also include detecting the anticipated transient operating event based on a change in vehicle operating parameters (e.g., a substantial torque demand increase that necessitates the starting of the engine 116). At 316, the control system 164 proactively controls the boost converter 144 based on the base torque commands and the predicted torque margins for the electric motors 120a and 120b, respectively. This could include, for example, proactively controlling the boost converter 144 to achieve higher voltages based on a sum of the base torque commands and the predicted torque margins. Finally, at 320, the control system 164 controls the electric motors 120 a and 120b based on their respective torque commands and using the proactively boosted voltage(s). The method 300 then ends or returns to 304 for one or more cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A predictive torque control system for an electrified vehicle, the predictive torque control system comprising:
an engine;
a power split hybrid transmission connected to the engine and comprising first and second electric motors;
a boost converter configured to convert and selectively boost a direct current (DC) voltage from a high voltage bus and a high voltage battery system to alternating current (AC) voltages supplied to the first and second electric motors of the power split hybrid transmission; and
a control system configured to:
determine base torque commands for the first and second electric motors based on a driver torque request;
predict torque margins for the first and second electric motors based on an anticipated transient operating event of the engine; and
proactively control the boost converter based on the predicted torque margins for the first and second electric motors, respectively.

2. The predictive torque control system of claim 1, wherein the control system is further configured to detect the anticipated transient operating event from a set of transient operating events including at least one of (i) a start operation of the engine, (ii) an entry to or exit from a deceleration fuel cutoff (DFCO) of the engine, (iii) an entry to fast path torque control of the engine, and (iv) an entry to or exit from a noise/vibration/harshness (NVH) zone of the engine.

3. The predictive torque control system of claim 1, wherein the control system is further configured to detect the anticipated transient operating event from a plurality of transient operating events including (i) a start operation of the engine, (ii) an entry to or exit from a deceleration fuel cutoff (DFCO) of the engine, (iii) an entry to fast path torque control of the engine, and (iv) an entry to or exit from a noise/vibration/harshness (NVH) zone of the engine.

4. The predictive torque control system of claim 3, wherein the control system is further configured to predict torque margins for each of the plurality of anticipated operating events and determine the predicted torque margins for the first and second electric motors as a maximum of the predicted torque margins.

5. The predictive torque control system of claim 1, wherein the proactive control of the boost converter decreases losses at an electrical system of the electrified vehicle.

6. The predictive torque control system of claim 1, wherein the proactive control of the boost converter increases a responsiveness of the power split hybrid transmission to the transient operating event of the engine.

7. The predictive torque control system of claim 1, wherein the anticipated transient operating event is a start operation of the engine, and wherein one of the first and second electric motors of the power split hybrid transmission is configured to control start/stop operation of the engine.

8. The predictive torque control system of claim 1, wherein the anticipated transient operating event is an entry to or exit from a deceleration fuel cutoff (DFCO) of the engine.

9. The predictive torque control system of claim 1, wherein the anticipated transient operating event is an entry to fast path torque control of the engine.

10. The predictive torque control system of claim 1, wherein the anticipated transient operating event is entry to or exit from a noise/vibration/harshness (NVH) zone of the engine where electric motor assistance is needed to decrease an NVH of the engine.

11. A predictive torque control method for an electrified vehicle having an engine, a power split hybrid transmission connected to the engine and comprising first and second electric motors, and a boost converter, the predictive torque control method comprising:
controlling, by a control system of the electrified vehicle, the boost converter configured to convert and selectively boost a direct current (DC) voltage from a high voltage bus and a high voltage battery system to alternating current (AC) voltages supplied to the first and second electric motors of the power split hybrid transmission;
determining, by the control system, base torque commands for the first and second electric motors based on a driver torque request;
predicting, by the control system, torque margins for the first and second electric motors based on an anticipated transient operating event of the engine; and
proactively controlling, by the control system, the boost converter based on the predicted torque margins for the first and second electric motors, respectively.

12. The predictive torque control method of claim 11, further comprising detecting, by the control system, the anticipated transient operating event from a set of transient operating events including at least one of (i) a start operation of the engine, (ii) an entry to or exit from a deceleration fuel cutoff (DFCO) of the engine, (iii) an entry to fast path torque control of the engine, and (iv) an entry to or exit from a noise/vibration/harshness (NVH) zone of the engine.

13. The predictive torque control method of claim 12, further comprising detecting, by the control system, the anticipated transient operating event from a plurality of transient operating events including (i) a start operation of the engine, (ii) an entry to or exit from a deceleration fuel cutoff (DFCO) of the engine, (iii) an entry to fast path torque control of the engine, and (iv) an entry to or exit from a noise/vibration/harshness (NVH) zone of the engine.

14. The predictive torque control method of claim 13, further comprising predicting, by the control system, torque margins for each of the plurality of transient operating events and determining, by the control system, the predicted torque margins for the first and second electric motors as a maximum of the predicted torque margins.

15. The predictive torque control method of claim 11, wherein the proactive controlling of the boost converter decreases losses at an electrical system of the electrified vehicle.

16. The predictive torque control method of claim 11, wherein the proactive controlling of the boost converter increases a responsiveness of the power split hybrid transmission to the transient operating event of the engine.

17. The predictive torque control method of claim 11, wherein the anticipated transient operating event is a start operation of the engine, and wherein one of the first and second electric motors of the power split hybrid transmission is configured to control start/stop operation of the engine.

18. The predictive torque control method of claim 11, wherein the anticipated transient operating event is an entry to or exit from a deceleration fuel cutoff (DFCO) of the engine.

19. The predictive torque control method of claim 11, wherein the anticipated transient operating event is an entry to fast path torque control of the engine.

20. The predictive torque control method of claim 11, wherein the anticipated transient operating event is entry to or exit from a noise/vibration/harshness (NVH) zone of the engine where electric motor assistance is needed to decrease an NVH of the engine.
